(19) United States
(12) Patent Application Publication
(10) Pub. No.: US 2014/0157872 A1
(43) Pub. Date: Jun. 12, 2014

(54) SENSING SYSTEMS

(71) Applicants: Mark Edward Welland, Cambridge (GB); Atif Aziz, Whittlesey (GB); Ian James Ganney, Great Cambourne (GB)

(72) Inventors: Mark Edward Welland, Cambridge (GB); Atif Aziz, Whittlesey (GB); Ian James Ganney, Great Cambourne (GB)

(73) Assignee: CAMBIDGE ENTERPTISE LIMITED, Cambridge, Cambridgeshire (GB)

(21) Appl. No.: 14/236,779

(22) PCT Filed: Aug. 3, 2012
(86) PCT No.: PCT/GB2012/051890

§ 371 Date: Feb. 3, 2014

(30) Foreign Application Priority Data
Aug. 4, 2011 (GB) 1113478.0

(51) Int. Cl. G01N 15/06

(52) U.S. Cl. CPC G01N 15/0656
USPC 73/28.02

(57) ABSTRACT

This invention relates to volcanic ash sensing techniques for aircraft, and to related sensing apparatus and methods. We thus describe a volcanic ash sensor for an aircraft, the sensor comprising: an electrically conducting ash charge collection device; an electrically insulating support for mounting said collection device in an air duct; and a charge measurement system having an input electrically coupled to said ash charge collection device; wherein said electrically conducting ash charge collection device is configured such that an air flow over said ash charge collection device is a turbulent flow; and wherein said charge measurement system is configured to determine a level of charge in said ash charge collection device to determine the presence of volcanic ash in said air flow.

### FIELD OF THE INVENTION

This invention relates to volcanic ash sensing techniques for aircraft, and to related sensing apparatus and methods.

### BACKGROUND TO THE INVENTION

The Eyjafjallajökull Eruption Crisis in April 2010 caused substantial economic losses in Europe, business disruption, and exacerbated global economic uncertainty. What was apparent during the crisis was our level of unpreparedness, and strikingly, our inability to reliably assess the risks of flying during volcanic activity.

Current volcanic ash observation methods and data issued by various meteorological, and air safety agencies, do not provide reliable measurements of the mass concentration of volcanic ash in air, information that is vital to the airlines, the aircraft manufacturers, and the aircraft engine manufacturers, as this concentration value is currently the only documented predictor of whether or not it is safe to fly, based on flight observation.

Remote sensing techniques such as LIDAR, IR Camera and satellite observations are primarily surface sensitive techniques and estimate mass per unit area of ash clouds. Remote sensing does not allow individual aircraft monitoring, nor does it enable the measurement of cumulative engine exposure to ingested particulates, an important consideration for making engine maintenance decisions.

Laser particle counters are an alternative to the sensors we propose below, however, with their detection method being optically-based, their exposure to dust and ash will degrade the sensor's performance over time. In addition, optically-based systems are typically fragile, sensitive to vibration and temperature fluctuations, and their longevity and reliability are compromised when exposed to elevated temperatures such as those experienced in bleed-air ducts.

Sensing volcanic ash presents special problems because the particle size is generally small, for example less than 3 μm. Volcanic ash also has sharp edges, which presents particular opportunities in relation to charge acquisition.

General background prior art can be found in: US2006/0150754; U.S. Pat. No. 5,621,208; GB1105604A; US2003/0006778; and JP59202055A.

### SUMMARY OF THE INVENTION

According to a first aspect of the invention there is also provided a volcanic ash sensor for an aircraft, the sensor comprising: an electrically conducting ash charge collection device; an electrically insulating support for mounting said collection device in an air duct; and a charge measurement system having an input electrically coupled to said ash charge collection device; wherein preferably said electrically conducting ash charge collection device is configured such that an air flow over said ash charge collection device is a turbulent flow; and wherein said charge measurement system is configured to determine a level of charge on said ash charge collection device to determine the presence of volcanic ash in said air flow.

In embodiments providing a turbulent air flow over the ash charge collection device increases the chances of ash particulates attaching to the sensor, and also enhances tribological electrical charging of the particles. In addition volcanic ash appears to be particularly able to acquire and retain an intrinsic charge.

In some preferred embodiments the ash charge collection device is generally conical (which here includes flared, for example trumpet-like, shapes). In preferred embodiments a surface of the device is provided with or comprises a plurality of ribs, steps, and/or openings (and/or wires and/or other formations), for example arranged in a generally circumferential fashion at intervals along a longitudinal length of the device, to cause said turbulent flow. Thus the surface of the device may, for example, be provided by a set of loops of wire of increasing size (diameter), disposed at intervals along a longitudinal length of the device, to approximate a generally conical surface; or a similarly arranged helical wire. The wire structure may be supported internally by fins of a (metal) support. Alternatively the device may have a stepped appearance akin to the outline of a Christmas tree. In embodiments the device is installed with a longitudinal axis of the cone along the air flow. The device may be installed, for example, in a pitot tube, supported by an electrically insulating spider.

The tribological charging of the ash particles provides a natural or intrinsic level of background charge. Surprisingly it has been found that this may be either positive or negative, but nonetheless accumulation of ash on the collection device tends to result in an overall positive or negative net charge on the device. However it can be useful in embodiments to apply an additional charge to the intrinsic or natural charge, and an electrode coupled to a power supply can be used to apply a known charge to the particles.

Thus, in embodiments, the sensor further comprises an ash charging electrode, for example a ring or loop, for mounting upstream of the ash charge collection device in the air flow, and a power supply to apply a voltage to this electrode. The degree of charge imparted to the ash can be controlled by controlling the duration and/or amplitude of a high voltage pulse applied to this electrode (typically greater than 100 volts for a sensor system having a transverse dimension less than 5 cm).

The charge measurement system may then compare the charge on the ash charge collection device when the voltage is present with the charge when the voltage is absent. In embodiments a pattern of positive and negative voltages (and/or zero voltage) may be applied to the charging electrode for improved ash detection/discrimination. The duration of a pulse may be relatively long, for example of order one second, depending upon the “relaxation time” of the ash charge collection device (which phrase is here used to mean the time over which the ash is removed from the device by the air flow).

Additionally or alternatively the sensor may include a pair of charged particle deflection electrodes upstream of the ash charge collection device, and a corresponding power supply to apply an electric field to these electrodes. This electric field may be employed to deflect intrinsically charged (or otherwise charged) ash particles and hence, for example, to determine an average polarity of the charge; and/or in a more sophisticated system an average charge-to-mass ratio for the particles; and/or an estimated average mass of the particles (in particular where a known charge is applied—using “mass spectrometer”-type principles).

Where the sensor incorporates particle deflection electrodes it is particularly preferable if the ash charge collection device comprises a pair of electrodes at different transverse locations within the air flow. For example a conical electrode may be divided longitudinally into two halves. Each electrode of the pair is then provided with a respective charge measuring system (which may potentially be the same system, multiplexed).

Such an arrangement may then be used to determine a differential level of charge on each electrode of the pair, for example for improved charge measurement of, or discrimination between, ash particles having a natural or tribological charge. In some preferred embodiments this arrangement of collection device electrodes is combined with particle deflection electrodes, so that opposite polarity electric fields can be applied across the deflection electrodes and a difference between the differential signals determined. In embodiments a suitable electric field for the deflection electrode can be generated with a few tens of volts.

The skilled person will appreciate that the deflection electric field may be varied in many ways, for example driven by a sinusoidal, triangular, rectangular or other wave shape, and optionally with varying amplitude and/or frequency. In embodiments a pattern of electric field changes may be applied, for example comprising first and second (positive and negative) polarity electric fields and, optionally, zero electric field strength. As previously mentioned such an approach can facilitate an estimation of the chargeability and/or mass and/or charge-to-mass ratio of the detected particles.

Surprisingly, a sensor as described above is also suitable for detecting liquid particles of a liquid mist. In an aircraft such a liquid may comprise oil, for example in a cabin air intake routed via an engine. An oil mist in a cabin air intake is potentially a health hazard and it is useful to be able to detect the presence of such an oil mist. Other liquids which may potentially be found include antifreeze (glycol) from aircraft de-icing. The sensor we describe appears to work with both polar and non-polar liquids.

A volcanic ash sensor may be mounted, say, on the wing of an aircraft. If a second sensor is included in a second air flow, for example in a cabin air intake, then a comparison between the particulates sensed within these two air flows can distinguish between oil and ash in the cabin air intake, and substantially only ash in the wing (or other) air intake. Embodiments of the sensor may also be employed to detect sand, smoke, dust, and other fine particles.

In a related aspect, therefore, the invention provides a solid or liquid particulate sensor comprising: an electrically conducting solid or liquid particulate charge collection device; an electrically insulating support for mounting said particulate charge collection device in an air duct; and a charge measurement system having an input electrically coupled to said particulate charge collection device; wherein said electrically conducting particulate charge collection device is configured such that an air flow over said particulate charge collection device is a turbulent flow; and wherein said charge measurement system is configured to determine a level of charge on said solid or liquid particulate charge collection device to determine the presence of solid or liquid particulates in said air flow.

In embodiments the charge measurement system may have a high impedance front-end provided a field effect transistor (or insulated gate bipolar transistor). The electrically conducting collection device may then be coupled to the gate (or base) of this transistor. Preferably the charge measurement system is self-calibrating, for example including circuitry to apply a known charge to the gate (or base) of this input transistor.

In embodiments the sensor is also self-cleaning. Thus although the ash charge collection device collects ash from the air flow, collected ash is also removed from the device by the air flow. Thus if ash is removed from the air flow a slow decay or relaxation of the measured charge is observed as the air flow cleans the collection device. In embodiments the sensor is arranged to balance the rate of collection of ash, so that sufficient output signal is generated, with a rate of self-cleaning.

In a further related aspect the invention provides a method of sensing volcanic ash particulates and/or liquid particles in an air flow, the method comprising: capturing said particulates on an electrically conducting charge collection device; and sensing said particulates responsive to a charge on said charge collection device; wherein said capturing comprises generating turbulence in said air flow to increase a proportion of particulates attaching to said charge collection device.

In embodiments the air flow over the ash charge collection device is turbulent when the aircraft is travelling at a speed of at least 100 m/sec. In embodiments the ash charge collection device is mounted in a duct or pitot tube and flow over the ash charge collection device is characterized by a Reynold's number of at least 2,100, preferably at least 3,000, more preferably at least 4,000.

The skilled person will appreciate that in other embodiments different features of the above described sensor may be combined.

Thus in a further aspect the invention provides a sensor for sensing volcanic ash particulates and/or liquid particles in an air flow, the sensor comprising: means for capturing said particles on an electrically conducting charge collection device; and means for sensing said particulates responsive to a charge on said charge collection device; and one or more of: means for generating turbulence in said air flow to increase a proportion of particulates attaching to said charge collection device; means for applying a determined level of charge to said particulates prior to said capturing; means for deflecting said particulates with a changing polarity electric field prior to said capturing; a said charge collection device comprising a pair of electrodes at different transverse locations within said air flow, wherein said means for sensing is configured to sense a differential charge on said pair of electrodes; means for determining an estimate of one or more of i) an electrical chargeability of said particulates; ii) an average mass of said particulates; and iii) a charge of mass ratio of said particulates; and means for discriminating between said liquid particulates and said volcanic ash particulates.

### BRIEF DESCRIPTION OF THE DRAWINGS

These and other aspects of the invention will now be further described, by way of example only, with reference to the accompanying figures in which:

FIGS. 1a and 1b show, respectively, a vertical cross section through a volcanic ash sensor according to an embodiment of the invention, and example ash charge collection devices for use with the sensor;

FIG. 2 shows an example charge detecting circuit for use with the sensor of FIG. 1;

FIGS. 3a and 3b show, respectively, a wind tunnel set up used to test the volcanic ash sensor of FIG. 1, and details of a filter system to collect ash particles without a filter (above) and with a filter installed (below);

FIGS. 4a and 4b show example charge vs mass calibration curves for, respectively, negatively and positively, charged particles;

FIGS. 5a to 5e show, respectively, an embodiment of a volcanic ash sensor incorporating an ash charging electrode, an illustration of the natural tribological background charging of ash, an example pulse train for driving the ash charging electrode, an example ash charging electrode drive waveform including positive, negative and zero voltage level portions, and a further example of an ash charging electrode drive waveform which begins negative and pulses to positive;

FIG. 6 shows a vertical cross section through a further example of an ash charge collection device divided into two halves, electrically; and

FIG. 7 shows a further example of a volcanic ash sensor according to an embodiment of the invention incorporating an ash charging electrode, a split ash charge collection device, and charged ash particle deflection electrodes.

### DETAILED DESCRIPTION OF PREFERRED EMBODIMENTS

We will describe systems and methods useful for detecting volcanic ash, but which can also be employed for detecting sand particles and aerosols, for example of aviation fluids in engine bleed air. The table below illustrates some of the damaging effects of volcanic ash (and sand), which are typically a function of duration of exposure, the concentration and type of ash, the engine power, and other factors. The table gives an indication of the levels of volcanic ash concentrations which it is desirable to detect. Additionally the Federal Aviation Authority has determined that (currently) flights in volcanic ash are acceptable up to volcanic ash concentration levels of 2 mg per cubic metre, operation in volcanic ash concentrations between 0.2 and 2 mg per cubic metre (in the absence of visible volcanic ash) being monitored. It is therefore desirable to be able to measure the level of volcanic ash, in particular on a commercial aircraft as outlined in the introduction. It is further desirable to be able to measure the level of sand particles the engine of an aircraft flying though a dry desert area is exposed to, because this has an effect on the frequency of energy service regimes.

Ash, sand and aviation-fluid aerosols are mainly dielectric in nature, and their surfaces readily charged triboelectrically in air. We will describe techniques which accurately measure their surface charge in order to determine their concentration. The techniques we describe below are able to perform charge sensing over a large dynamic range, for establishing a relationship between the measured charge and the ash, sand or aerosol concentration.

Volcanic Ash Exposure (Relevant experience)

| | Concentration | Duration | |
|---|---|---|---|
| Contaminate | (mg/m³) | (Minutes) | Observation |
| Volcanic Ash | 2,000 est. | 1 | Turbine nozzle debris |
| | | | leading to Stall/Power |
| | | | loss |
| “Earth mix 1” | 780 | 12 | Turbine nozzle debris |
| | | | leading to Stall & Power |
| | | | loss |
| “Earth mix 2” | 500 | 7 | Turbine nozzle debris |
| | | | buildup |
| “Earth mix 2” | 250 | 7 | Turbine nozzle debris |
| | | | buildup |
| Sand/Dust | 53 | 50 | Compressor blade erosion |
| (Storms) | | | leading to performance |
| | | | loss |
| Desert | 2 | Few hours | Compressor blade erosion |
| Environment | | | and loss of cooling |
| (Severe) | | | capability leading to hot |
| | | | part premature burnout. |
| Desert | 0.2 | Yearly | Compressor blade erosion |
| Environment | | average | and loss of cooling |
| | | | capabality leading to hot |
| | | | part premature burnout. |

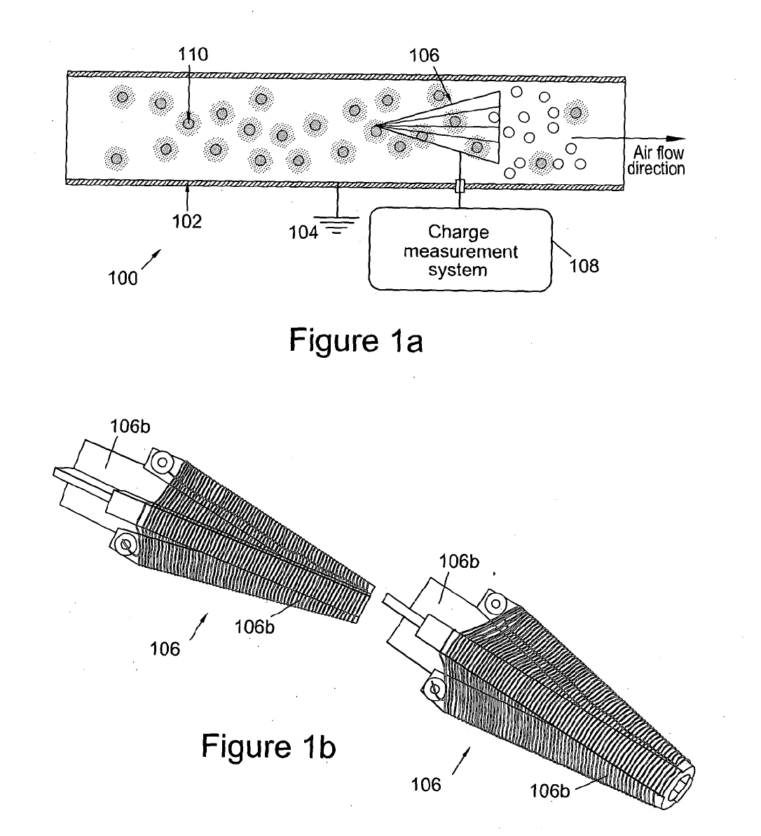

Thus, referring to FIG. 1a, this shows an embodiment of a volcanic ash sensor 100 for an aircraft, comprising a metal tube 102 such as a bleed air duct, having a ground connection 104, and in which is located a charge collector 106, electrically coupled to a charge measurement system 108. The air flow direction in FIG. 1a is left to right, and the air flow carries charged particles 110 which are collected by the collection device 106, allowing their collective charge to be measured.

The charge collector is configured to optimise charge transfer from the ash particles to the electrically conductive collector, and thence to the charge measurement system 108 where the net charge of the ash (and/or aerosol) particles is detected and a determination of their mass concentration is established.

FIG. 1b shows different views of a prototype ash charge collection device 106 comprising a cone-shaped copper coil 106a on a metal support 106b. in other embodiments the charge collector may comprise a metal, for example copper or nickel-chromium, space-frame structure. In principle a single wire across the tube 102 may be employed, or a set of wires or spider's web type arrangement in a lateral cross section of the tube. However to increase the available sensing area a coil winding is used as illustrated, providing a greater exposure area to the particles to be sensed whilst offering relatively low air resistance. In embodiments the ash charge collection device is installed in an air bleed duct.

In operation, in embodiments of the sensor, having transferred their charge to the collector 106, the particles continue on their flow path, as illustrated in FIG. 1a. In embodiments (as described further later) the surface of the collector is structured to create a turbulent flow which increases the captured charge, thus increasing the efficiency of the sensor.

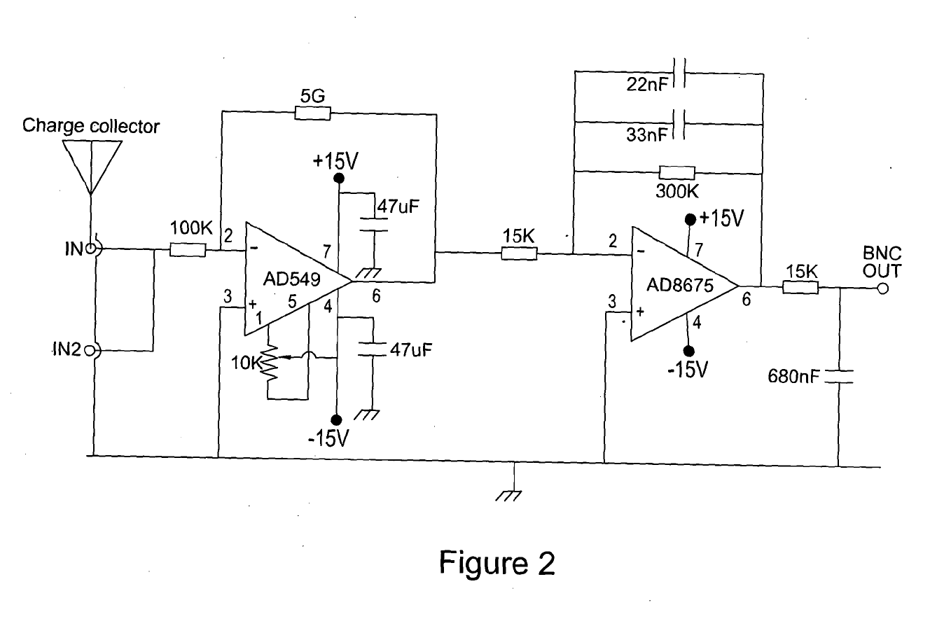

An example circuit for the charge measurement system 108 is shown in FIG. 2, which illustrates a charge sensing circuit (electrometer) with a very high input impedance provided by an operational amplifier with low input current JFETs (the potentiometer allows the input off set voltage to be nulled). This is coupled to a second low-offset operational amplifier which may then provide, for example, a voltage input to an analogue/digital converter for further processing and/or near an input to a pilot warning system. In embodiments a simple audio and/or visual warning system may be provided, for example a red light, to indicate the presence of ash or other detected particulate matter. Optionally the collected data may also be logged for later use, for example in mapping ash concentrations and/or particle size distributions over time (charge scales with size).

The charge detecting circuit of FIG. 2 is able to detect both positive and negative charges; this is useful because particles may be charged either positively or negatively.

Where multiple charge collection electrodes are employed similar circuits may be connected to each of two or more separate electrodes.

Optionally the volcanic ash sensing system may also include a temperature sensing system to measure the local temperature (of the air flow) to enable the output to be more accurately calibrated by compensating for variations in temperature.

A particulate/aerosol sensor as described above is self-cleaning to a degree as the air flow over the sensor removes ash from the sensor. However in embodiments ash builds up on the sensor until the slow decay of the ash removal from the sensor is balanced by the rate of ash collection. Thus in embodiments of the invention the ash charge collection device acts as, and may be considered as, an ash collection device.

Additionally, embodiments of the sensor may include a sensor cleaning system. This may be provided by means for heating the charge collector 106 to an elevated temperature to remove organic impurities. In the charge collector of FIG. 1b this may be achieved by periodically heating the sensor wire, for example electrically.

Embodiments of the sensor may also be electrically self-calibrating, for example by providing in the charge measurement system a circuit to apply a known charge to the input of the charge measurement system (electrometer), for example at IN2 of FIG. 2.

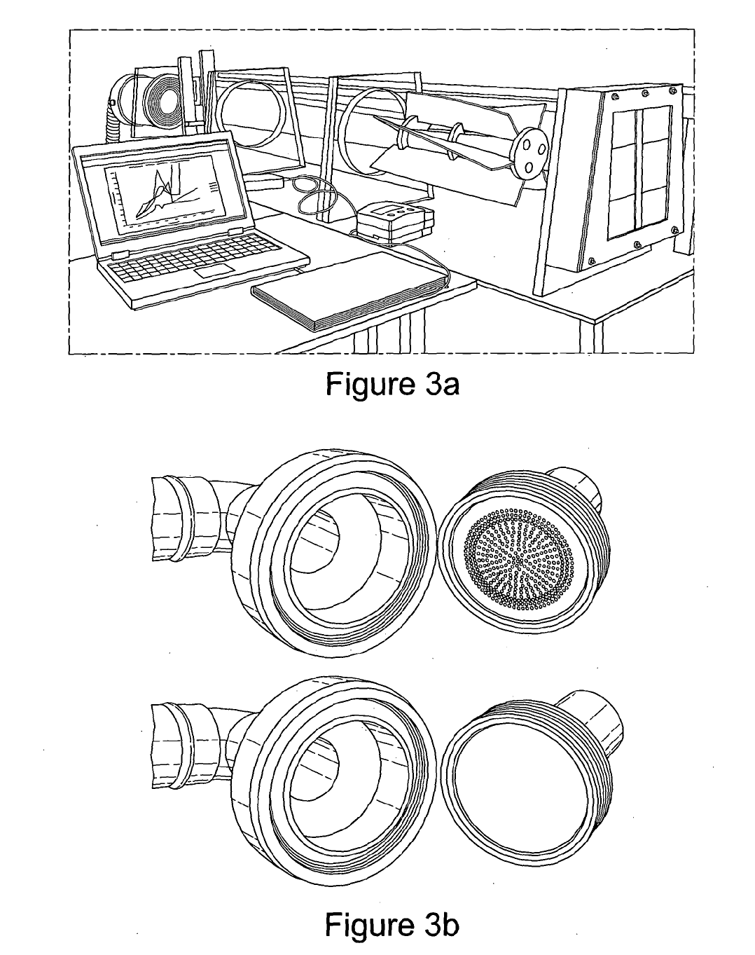

FIGS. 3a and 3b show an experimental rig used for calibrating the charge sensor for measuring particle mass concentration. The rig comprises an injection device, which introduces particulates at a constant flow rate into the illustrated wind tunnel: particulates are mixed with pressurised argon gas and injected into the wind tunnel; magnesium silicate hydroxide particles may be employed as a proxy for ash. The particulate flow rate can be controlled by modulating the argon gas pressure. Particles are triboelectrically charged in the tunnel, and when they collide with the charge collector transfer their surface charge which is detected and measured by the charge measurement system (electrometer). Having transferred their charge to the sensor, the particles are collected using a fine filter (FIG. 3b). The total charge collected by the electrometer is compared with the total particle mass by the filter and measured with a microbalance, relative to the volume of air that has flowed through the sensor and filter (measured with a digital flow meter).

Thus, broadly speaking, ash particles are carefully collected after they have transferred their charge to the ash collecting device, and weighed using a very sensitive scale. Air flow rate is measured using a flowmeter, and using charge, ash mass and the flow rate a calibration curve is established from which mass per unit volume is obtained.

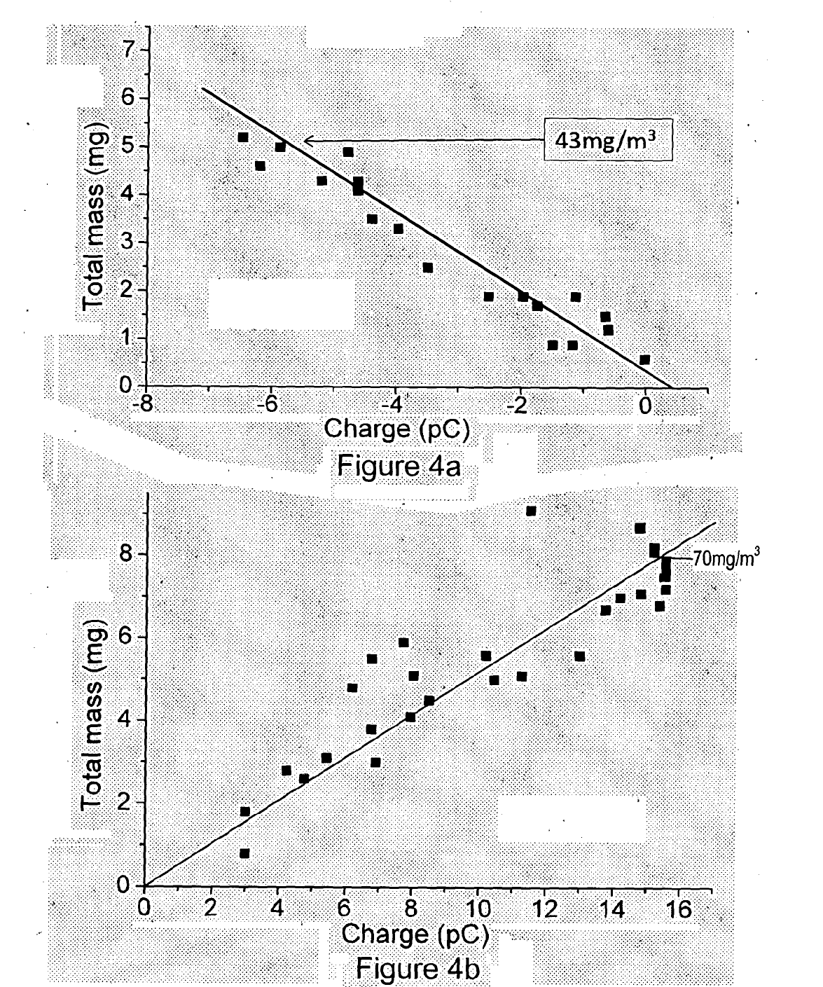

FIG. 4a illustrates a typical charge versus mass calibration curve obtained from the rig for negatively charged particles, and FIG. 4b illustrates a similar calibration curve for positively charged particles. The system may detect concentrations down to 0.1 mg per meter mg/m^{3;} optionally heating elements may be included in the test rig to enable measurements from ambient temperature up to, for example, around 400° C. Optionally the rig may be modified to replicate bleed-air duct conditions.

Measurable charge signals may be obtained from volcanic ash, sand a compressor wash, antifreeze, and turbo oil. The system may be used to calibrate the sensor for various volcanic ash and sand particles morphologies, compositions, and particle size distributions. Aviation fluids of different compositions may also be characterised.

Embodiments of the sensor system are very sensitive and have a large measurement range and, more particularly, are able to measure a mass concentration of particles, including ash and sand, and aerosols such as engine oil, compressor wash and antifreeze, from less than 0.1 mg per meter mg/m³ to 3,000 mg per meter mg/m^{3,} embodiments of the sensor are light, robust, resistant to elevated temperatures and vibration, have no moving parts or optics and have low operating power requirements. To detect volcanic ash/sand the sensor may be mounted on an aircraft wing, for example on an insulated mount in a pitot tube. To detect, for example, oil mist vapour in an aircraft cabin the sensor may be mounted in a cabin air intake, for example a pre-heated cabin air intake taken off an engine. Optionally in either case a removeable filter may be provided down stream of the sensor, so that this can be examined later, for example for validation/calibration of the detected particulate concentration.

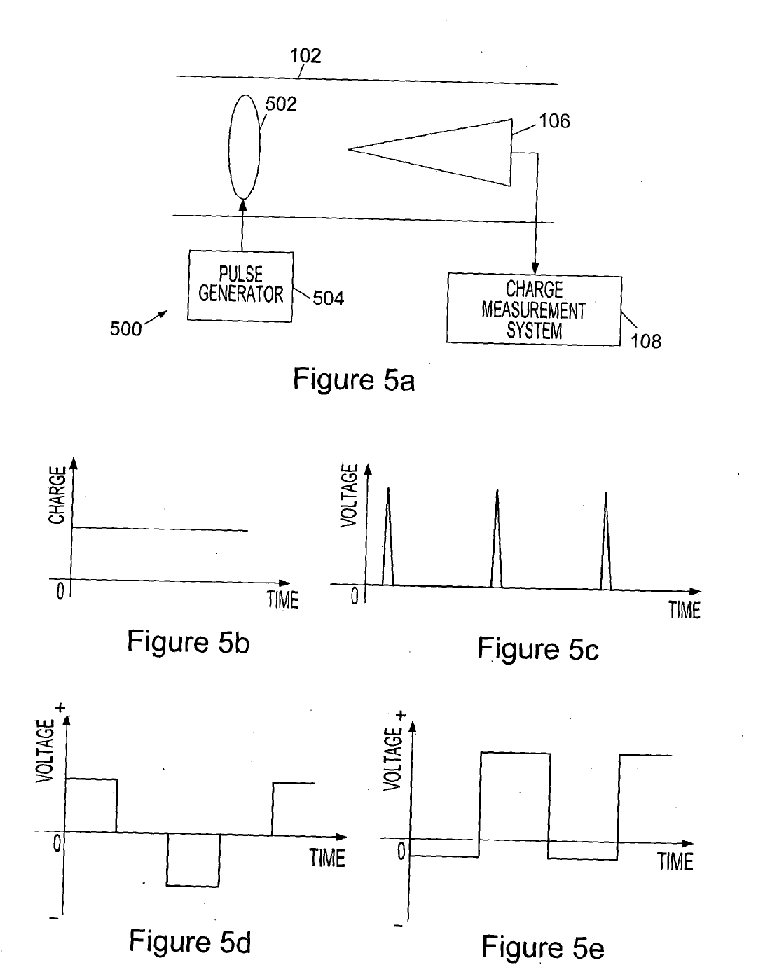

Referring now to FIG. 5a, this shows, schematically a further embodiment of a volcanic ash sensor 500 according to the invention, in which like elements to those previously described are indicated by like reference numerals. The arrangement of FIG. 5 includes a ring-shaped electrode 502 upstream of charge collector 106 in the airflow, coupled to a pulse generator 504. The pulse generator applies a known electric field to the particles via electrode 502, and is therefore able to apply a known charge to the particles.

Volcanic ash particles have relatively sharp edges and acquire charge easily; these have an intrinsic background level of charge density as illustrated in FIG. 5b. It is observed that this appears to be positive. (By contrast sand-silica—has less sharp edges and appears to be able to possess either a positive or negative ‘intrinsic’ charge).

FIG. 5c illustrates, schematically, a simple voltage pulse pattern which may be applied to electrode 502. However in some preferred embodiments relatively long electrical pulses, for example of order one second on, one second off, are applied to facilitate distinguishing between the known, applied charge and the background, intrinsic charge of the particles by determining a difference in charge between the electric field on and electric field off states. An example of such a pulse train is illustrated schematically in FIG. 5d.

FIG. 5e shows a variant of the pulse trainer FIG. 5b in which a positive voltage is applied to electrode 502 starting from a lesser, negative voltage baseline.

Depending upon the particles sensed, some particles may be tribologically charged positively, and some tribologically charged negatively, and it can be useful to discriminate between these. This can be achieved by employing two charge collectors, one for sensing positive particles, the other for sensing negative particles; optionally a differential signal may then be generated and used for example for sensing a threshold level of volcanic ash (embodiments of the sensor with only a single charge collector may provide an ash-detection signal by comparing the detected charge with a threshold level, for example a level set in response to a tolerable level of volcanic ash).

A preferred version of the sensor employing two charge collectors, one for positive and one for negative particles, further comprises an ‘electrical gate’ comprising one or more electrodes to divert the positively and negatively charged particles in different directions. This may comprise, for example, a pair of parallel plates similar to the plates of a capacitor. Optionally then the deflection voltage applied to these one or more electrodes may be modulated to provide a modulated charge-detection signal (either a single-ended signal or a differential signal). Such modulation facilitates determining a charge distribution on the particles, and hence providing more accurate detection/discrimination of volcanic ash particles.

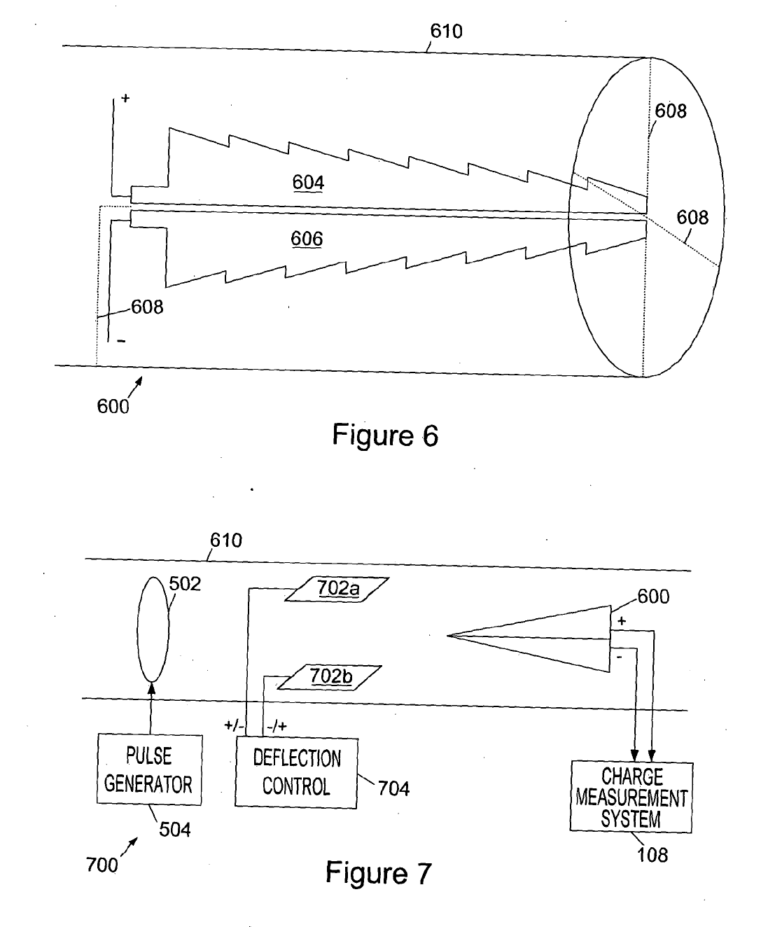

FIG. 6 shows a vertical cross-section through an embodiment of an ash charged collection device 600 which is electrically divided into two portions 604, 606, for collecting positively charged and negatively charged particles. As illustrated the device is mounted on an insulating spider mount 608 within a pitot tube 610.

The illustrated ash charge collection device has a ‘Christmas tree’ type appearance in which the surface is stepped or ribbed in order to provide a turbulent airflow over the sensor. The illustrated sensor has an increased surface area, and thus greater probability of charged particle capture, and this is enhanced by flow separation in the air flow over the device which also increases the probability of particle capture. In laymen's terms the particles are trapped in the gulley's, swirl around, and attach to the metal.

The arrangement of FIG. 6 illustrates a conducting device but in other embodiments the structure of the charge collection device comprises a set of metal ribs or other formations spaced apart over an insulating support (or having air gaps between), with the metal ribs electrically connected to one another. Thus in embodiments the ash charge collection device may comprise electrical elements mounted on an insulating surface. Although in the illustrated example the steps or ribs extend circumferentially, additionally or alternatively ribs or other formations may extend in a generally longitudinal direction, or potentially other sensor surface formations may be employed, for example a helical formation.

In embodiments an ash charge collection device, for example of the type illustrated in FIG. 6, may be formed from stainless steel mounted on teflon. These materials are particularly advantageous because they are relatively temperature-insensitive and water-insensitive.

As shown schematically in FIG. 6, in embodiments of the split ash charge collection device separate positive and negative connections are brought out from the sensor through the enclosing tube to the charge measurement system—which may comprise, for example, a circuit of the type shown in FIG. 2 for each portion of the device.

FIG. 7 illustrates an embodiment of a volcanic ash sensing system 700, again in which like elements to those previously described are indicated by like reference numerals. The arrangement of FIG. 7 includes a pair of parallel plates 702a, b in the air flow coupled to a deflection controller 704 configured to apply an electrical field across the plates, for example by applying a relatively large voltage between the plates. In embodiments the electric field may be adjusted or modulated, more particularly modulated so that it alternates in direction, again to facilitate charged particle detection by detection of a differential signal. A deflection waveform may be of the type illustrated in FIG. 5d or FIG. 5e; a waveform of the type shown in FIG. 5d includes a zero-field portion, which can be useful in deriving a background signal for subtraction from the signal observed when an electric field is applied.

In operation, a differential signal may be derived from the split charge collection device 600, and this differential signal modified by applying positive and negative electric fuels to the electrodes 702 to generate a variation in this differential signal (a differential signal), the change in differential signal being responsive to the flow of negative versus positive particles in the air stream. Optionally the electrical field modulation applied to electrodes 702 may be synchronised with the charging electric field applied to an electrode 502, for synchronous detection.

In embodiments a voltage of order 10s of volts may be applied to plates 702 and a voltage of order 100s of volts may be applied to electrode 502. the larger the voltage applied to electrode 502, the larger the charge acquired by the particles and use of a large voltage can be employed to dominate and reduce the influence of natural tribological charging. However, as previously discussed, detection of the natural or intrinsic tribological charge is particularly useful for volcanic ash detection because volcanic ash appears to be intrinsically charged (perhaps during its creation process) and to naturally retain its charge. Thus for volcanic ash detection a measurement of the intrinsic, tribological charge of the particles is particularly useful. Thus the skilled person will appreciate that embodiments of a volcanic ash sensor may omit either or both of the charge application system 502, 504, and the charge particle deflection control system 702, 704 of FIG. 7.

Nonetheless, the arrangement of FIG. 7 has some particular advantages for charged particle detection because the charge application system is able to apply a charge to the particles which depends upon the chargeability of the particles, whilst the deflection control system is able to apply a known electric field to the population of particles which will, in general, comprise positively charged particles, negatively charged particles, and/or substantially neutral particles. The effectively known charge and known electric field can be used, optionally inc combination with the known velocity of the air flow (which may be determined from the velocity of the aircraft) to, in effect, perform mass spectrometry on the particles by determining a mass-to-chargeability ratio using the sensor. This in turn may be employed for greater discrimination/accuracy of the sensing system.

The sensing systems and techniques we have described are particularly useful for sensing volcanic ash, but, as previously mentioned, may also be employed for detecting other particulates/aerosols of interest in an aircraft. In principle, however, other applications are also possible for the sensor technology. For example a sensor of the same general type as described above may be employed in a vacuum cleaner, for example after the air filter to detect particulate matter such as house-mite dust (which is very small and hard to detect) and/or pollen. Such an arrangement is particularly useful after the air filter in a cyclonic separation-type vacuum cleaner. Such a sensor can be useful, for example, for allergy reduction and may provide an audio and/or visual alert when, say, the filter needs replacing. Another potential application for the technology is in a mine where low concentrations of fine dust may be detected, for early detection of a potential explosion hazard.

No doubt many other effective alternatives will occur to the skilled person. It will be understood that the invention is not limited to the described embodiments and encompasses modifications apparent to those skilled in the art lying within the spirit and scope of the claims appended hereto.

1. A volcanic ash sensor for an aircraft, the sensor comprising:
an electrically conducting ash charge collection device;
an electrically insulating support for mounting said collection device in an air duct; and
a charge measurement system having an input electrically coupled to said ash charge collection device; and
wherein said charge measurement system is configured to determine a level of charge on said ash charge collection device to determine the presence of volcanic ash in said air flow.

2. A volcanic ash sensor as claimed in claim 1 wherein said electrically conducting ash charge collection device is configured such that an air flow over said ash charge collection device is a turbulent flow.

3. A volcanic ash sensor as claimed in claim 1 wherein a surface of said ash charge collection device has a plurality of ribs, steps, and/or openings.

4. A volcanic ash sensor as claimed in claim 1 wherein said ash charge collection device is generally conical.

5. A volcanic ash sensor as claimed in claim 1 further comprising an ash charging electrode for mounting upstream of said ash charge collection device in said air flow, and a particle charging electrical power supply coupled to said ash charging electrode to apply a voltage to said charging electrode charging said ash.

6. A volcanic ash sensor as claimed in claim 5 wherein said charge measurement system is configured to determine data dependent on chargeability of said ash to determine the presence of volcanic ash in said air flow.

7. A volcanic ash sensor as claimed in claim 6 wherein said particle charging electrical power supply is configured to supply a positive and a negative voltage to said charging electrode for determining said chargeability.

8. A volcanic ash sensor as claimed in claim 1 further comprising a pair of charged particle deflection electrodes for mounting upstream of said ash charge collection device in said air flow, and a particle deflection electrical power supply to apply an electric field across said pair of electrodes to deflect ash particles in said air flow.

9. A volcanic ash sensor as claimed in claim 8 wherein said particle deflection electrical power supply is configured to apply changing polarity electric field across said pair of charged particle deflection electrodes, and wherein said charge measurement system is responsive to a varying charge on said ash charge collection device due to said alternating electric field to determine the presence of volcanic ash in said air flow.

10. A volcanic ash sensor as claimed in claim 1 wherein said electrically conducting ash charge collection device comprises a pair of separate adjacent collection electrodes, and wherein said charge measurement system is configured to determine a differential said level of charge on said pair of collection electrodes to determine the presence of volcanic ash in said air flow.

11. A volcanic ash sensor as claimed in claim 10 further comprising a pair of charged particle deflection electrodes for mounting upstream of said ash charge collection device in said air flow, and a particle deflection electrical power supply to apply an electric field across said pair of electrodes to deflect ash particles in said air flow,
wherein said particle deflection electrical power supply is configured to apply changing polarity electric field across said pair of charged particle deflection electrodes,
wherein said charge measurement system is responsive to a varying charge on said ash charge collection device due to said alternating electric field to determine the presence of volcanic ash in said air flow, and
wherein said charge measurement system is configured to determine a variation in said differential level of charge on said pair of collection electrodes to determine the presence of volcanic ash in said air flow.

12. A volcanic ash sensor as claimed in claim 1 wherein said charge measurement system is further configured to determine the presence of a liquid mist in said air flow.

13. A pair of volcanic ash sensors each as recited in claim 1 incorporated into a liquid mist sensing system for an aircraft, the system further comprising a comparator to compare outputs from the respective charge measuring systems of the sensors to identify the presence of a liquid mist in a said air flow.

14. (canceled)

15. A method of sensing volcanic ash particulates and/or liquid particles in an air flow, the method comprising:
capturing said particulates on an electrically conducting charge collection device; and
sensing said particulates responsive to a charge on said charge collection device;
wherein said capturing comprises generating turbulence in said air flow to increase a proportion of particulates attaching to said charge collection device.

16. A method as claimed in claim 15 further comprising applying a determined level of charge to said particulates prior to said capturing.

17. A method as claimed in claim 15 comprising deflecting said particulates with a changing polarity electric field prior to said capturing.

18. A method as claimed in claim 15 wherein said charge collection device comprises a pair of electrodes at different transverse locations within said air flow, and wherein said sensing comprises sensing a differential charge on said pair of electrodes.

19. A method as claimed in claim 15 wherein said sensing further comprises determining an estimate of one or more of i) electrical chargeability of said particulates; ii) an average mass of said particulates; and iii) a charge of mass ratio of said particulates.

20. A method as claimed in claim 15 further comprising discriminating between liquid particulates and volcanic ash particulates.

21. (canceled)

22. A sensor for sensing volcanic ash particulates in an air flow, the sensor comprising:
an ash capture device to capture volcanic ash particulates on an electrically conducting charge collection structure;
an electrical charger to apply charge to said particulates prior to said capturing;
a sensor to sense said particulates responsive to a charge on said charge collection structure; and
a discrimination system to discriminate between said volcanic ash particulates and other particulates in said air flow captured on said structure.
